(19) United States
(12) Patent Application Publication
(10) Pub. No.: US 2019/0065395 A1
(43) Pub. Date: Feb. 28, 2019

(54) STORAGE DEVICE AND DATA ARRANGEMENT METHOD

(71) Applicant: TOSHIBA MEMORY CORPORATION, Tokyo (JP)

(72) Inventor: Takafumi FUJITA, Yokohama Kanagawa (JP)

(21) Appl. No.: 16/002,277

(22) Filed: Jun. 7, 2018

(30) Foreign Application Priority Data
Aug. 30, 2017 (JP) 2017-165570

(51) Int. Cl. G06F 12/1009

(52) U.S. Cl. CPC G06F 12/1009; G06F 2212/7201; G06F 2212/657; G06F 2212/1008

(57) ABSTRACT

A storage device includes a nonvolatile memory and a controller configured to access the nonvolatile memory in response to a command from a host apparatus. In response to a first command which includes a first logical address and a second logical address, the controller updates a logical-to-physical address conversion map to correlate the second logical address with a physical address of the nonvolatile memory to which the first logical address is correlated. In response to a second command which includes the first logical address, the controller updates the logical-to-physical address conversion map to invalidate the correlation between the first logical address and the physical address.

### CROSS-REFERENCE TO RELATED APPLICATION

This application is based upon and claims the benefit of priority from Japanese Patent Application No. 2017-165570, filed Aug. 30, 2017, the entire contents of which are incorporated herein by reference.

### FIELD

Embodiments described herein relate generally to a storage device and a data arrangement method.

### BACKGROUND

In recent years, storage devices implemented with a nonvolatile semiconductor memory have been widely used. As one of such storage devices, a solid state drive (SSD) including NAND type flash memory is well known. The SSD has advantages such as high performance and low power consumption, and has been used as main storage in various information processing apparatuses, such as a personal computer (PC) and a server, instead of a hard disk drive (HDD).

### DESCRIPTION OF THE DRAWINGS

FIG. 1 is a diagram illustrating an example of a configuration of a storage device of an embodiment.

FIG. 2 is a first diagram for explaining a comparative example of a defragmentation method.

FIG. 3 is a second diagram for explaining a comparative example of the defragmentation method.

FIG. 4 is a third diagram for explaining a comparative example of the defragmentation method.

FIG. 5 is a fourth diagram for explaining the comparative example of the defragmentation method.

FIG. 6 is a fifth diagram for explaining the comparative example of the defragmentation method.

FIG. 7 is a first diagram for explaining an example of a data arrangement method applied to the storage device of the embodiment.

FIG. 8 is a second diagram for explaining the example of the data arrangement method applied to the storage device of the embodiment.

FIG. 9 is a third diagram for explaining the example of the data arrangement method applied to the storage device of the embodiment.

FIG. 10 is a fourth diagram for explaining the example of the data arrangement method applied to the storage device of the embodiment.

FIG. 11 is a fifth diagram for explaining the example of the data arrangement method applied to the storage device of the embodiment.

FIG. 12 is a diagram illustrating a format of an NVMe® command.

FIG. 13 is a diagram illustrating a list of Opcodes for NVMe® commands.

FIG. 14 is a diagram illustrating a format of a double word in a case where the NVMe® command is a Dataset Management command.

FIG. 15 is a diagram illustrating a flow of a data arrangement process performed through cooperation between the storage device of the embodiment and a host apparatus.

### DETAILED DESCRIPTION

In the case of the HDD, if fragmentation of data recorded on a disk progresses, movement of a head increases during accesses to the disk, and thus the performance thereof deteriorates. Thus, it is necessary to perform arrangement of data (known as defragmentation) as appropriate. In contrast, in the case of the SSD in which random access is performed at a high speed, fragmentation of data on a physical address space does not cause deterioration in performance, and thus defragmentation is inherently unnecessary. However, fragmentation of data on a logical address space (also said to be fragmentation of a vacant region) increases a load on a host apparatus side, and, thus, generally, in the SSD, defragmentation is also performed in the same manner as the HDD to reduce fragmentation of data on the logical address space. The SSD, in which overwriting data cannot be performed unlike the HDD, has a function of erasing data which has been erased from the logical address space, also from a physical address space at any timing.

However, in the case of the SSD, if the defragmentation is performed, movement of data in the physical address space, which is inherently unnecessary, occurs, and thus a write amplification factor (WAF) is increased.

Embodiments provide a storage device and a data arrangement method, capable of preventing an increase in the WAF due to the defragmentation.

In general, according to one embodiment, there is provided a storage device including a nonvolatile memory and a controller configured to access the nonvolatile memory in response to a command from a host apparatus. In response to a first command which includes a first logical address and a second logical address, the controller updates a logical-to-physical address conversion map to correlate the second logical address with a physical address of the nonvolatile memory to which the first logical address is correlated. In response to a second command which includes the first logical address, the controller updates the logical-to-physical address conversion map to invalidate the correlation between the first logical address and the physical address.

Hereinafter, an embodiment will be described with reference to the drawings.

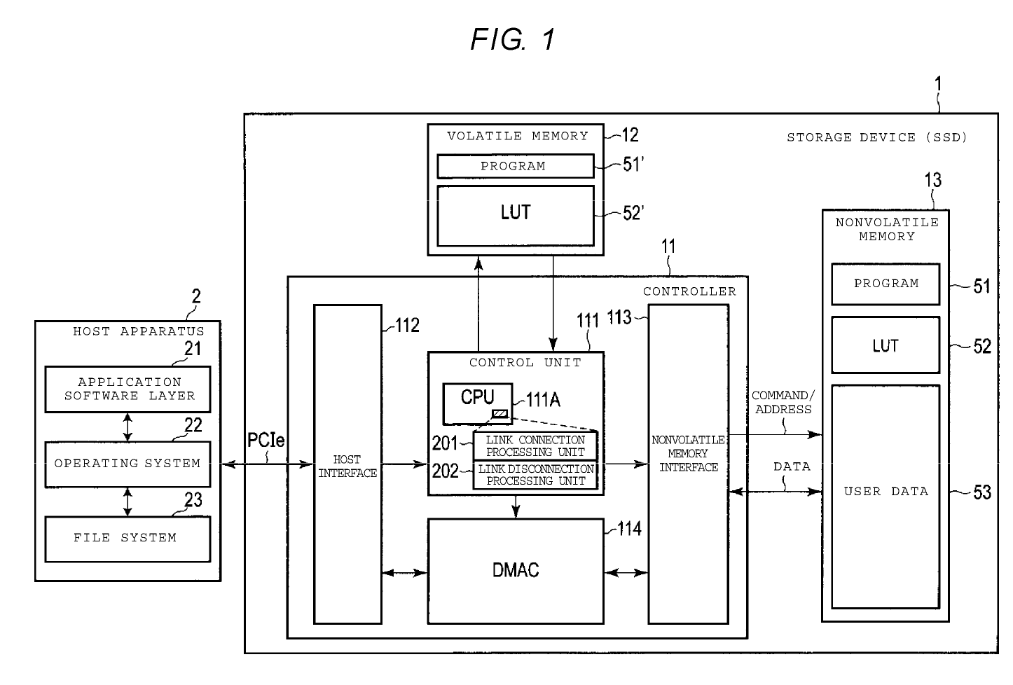

FIG. 1 is a diagram illustrating an example of a configuration of a storage device 1 according to the present embodiment. Herein, for example, it is assumed that the storage device 1 is an SSD used as a main storage of a host apparatus 2. The storage device 1 is not limited to an SSD, and may be other various types of storages such as a hybrid disk drive. The storage device 1 may be built into the host apparatus 2, and may be externally connected to the host apparatus 2.

The host apparatus 2 is an information processing apparatus such as a PC or a server. The storage device 1 is connected to the host apparatus 2 via an interface based on, for example, the PCI Express (PCIe®) standard. The storage device 1 performs communication with the host apparatus 2 by using a protocol based on, for example, the NVM Express (NVMe®) standard. Herein, it is assumed that a command defined in NVMe® is issued from the host apparatus 2 to the storage device 1. A data arrangement method of the present embodiment which will be described later is not limited to PCIe® or NVMe®, and may be implemented by other various types of interfaces or protocols.

The host apparatus 2, which is an information processing apparatus, executes various programs. The programs executed by the host apparatus 2 include an application software layer 21, an operating system (OS) 22, and a file system 23. The operating system 22 is software which is configured to manage the entire host apparatus 2, control hardware in the host apparatus 2, and perform control for allowing application software to use the hardware in the host apparatus 2 and the storage device 1. The file system 23 is used to perform control for operations (such as creation, storing, update, removal, and the like) of a file. Various pieces of application software run on the application software layer 21. When application software needs to send a request such as a write/read command to the storage device 1, the application software layer 21 sends the request to the operating system 22. The operating system 22 sends the request to the file system 23. The file system 23 translates the request into a command (such as a write/read command or the like). The file system 23 sends the command to the storage device 1. When a response is received from the storage device 1, the file system 23 sends the response to the operating system 22. The operating system 22 sends the response to the application software layer 21.

As illustrated in FIG. 1, the storage device 1 includes a controller 11, a volatile memory 12, and a nonvolatile memory 13. Herein, the storage device 1 is assumed to include the volatile memory 12, but may not include the volatile memory 12. The controller 11 includes a control unit 111, a host interface 112, a nonvolatile memory interface 113, and a DMA controller (DMAC) 114. The control unit 111 includes a CPU 111A.

Programs 51 for causing the storage device 1 to perform various procedures are stored in a predetermined region of the nonvolatile memory 13. Some or all of the programs 51 stored in the predetermined region of the nonvolatile memory 13 are loaded into the volatile memory 12, for example, during a start-up of the storage device 1, and are executed by the CPU 111A of the control unit 111. Various processing units can be implemented in the storage device 1 through the programs 51. The various processing units include a link connection processing unit 201 and a link disconnection processing unit 202.

A lookup table (LUT) 52 and user data 53 are stored in the nonvolatile memory 13. The LUT 52 is a table for managing a correspondence relationship between a logical address (LBA) that the host apparatus 2 manages and a physical storage position on the nonvolatile memory 13, that is, a correspondence relationship between a logical address space and a physical address space. A storage region of the nonvolatile memory 13 is managed in a predetermined size unit, and, for example, a head physical address of each storage region with the predetermined size is managed to be correlated with a logical address on the LUT 52. A part or the whole of the LUT 52 is loaded into the volatile memory 12 to be referred to, and an updated content of the LUT 52 in the volatile memory 12 is non-volatilized into the nonvolatile memory 13 at a predetermined timing. A correspondence relationship between a region on a logical address space and a region on a physical address space, which is managed in the LUT 52, may be referred to as a link. The user data 53 is data received from the host apparatus 2.

The nonvolatile memory 13 is, for example, a NAND flash memory. The NAND flash memory is only an example, and, for example, other various types of nonvolatile semiconductor memories such as a resistive RAM (ReRAM) may be used. The volatile memory 12 is, for example, a dynamic RAM (DRAM).

The controller 11 is a processing circuit such as a system-on-a-chip (SoC) which receives a write/read command from the host apparatus 2, writes data (user data 53) transmitted from the host apparatus 2 to the nonvolatile memory 13 while using the volatile memory 12 as a buffer, and reads data for which the host apparatus 2 makes a request, from the nonvolatile memory 13. An operation of the controller 11 is controlled by the control unit 111, more specifically, the CPU 111A executing the programs 51. In other words, the host interface 112, the nonvolatile memory interface 113, and the DMAC 114 are operated under the control of the control unit 111.

The host interface 112 controls communication with the host apparatus 2. On the other hand, the nonvolatile memory interface 113 controls communication with the nonvolatile memory 13. The DMAC 114 controls data transmission between the host interface 112 and the nonvolatile memory interface 113. More specifically, the DMAC 114 controls data transmission between the host interface 112 and the volatile memory 12, and data transmission between the volatile memory 12 and the nonvolatile memory interface 113.

If a read command is issued from the host apparatus 2, the control unit 111 is notified of the read command via the host interface 112. The read command includes a start logical address of reading target data and a data length. The control unit 111 refers to the LUT 52 on the volatile memory 12, and acquires physical addresses respectively correlated with one or more logical addresses including the leading logical address. In the case where the data length is equal to or less than the predetermined size which is the management unit of a storage region of the nonvolatile memory 13, a single physical address is acquired, and, in the case where the data length exceeds the predetermined size, two or more physical addresses are acquired. The control unit 111 issues a request for reading data stored in the acquired physical address to the nonvolatile memory 13 via the nonvolatile memory interface 113. The control unit 111 requests the DMAC 114 to transmit the data read from the nonvolatile memory 13 between the nonvolatile memory interface 113 and the host interface 112. The data read from the nonvolatile memory 13 is returned to the host apparatus 2 via the nonvolatile memory interface 113 and the host interface 112 by using the volatile memory 12 as a buffer.

For example, if a write command is issued from the host apparatus 2, the control unit 111 is notified of the write command via the host interface 112. The write command includes write data, a leading logical address of a write destination, and a data length. The write data is transmitted from the host interface 112 to the nonvolatile memory interface 113 by using the volatile memory 12 as a buffer under the control of the DMAC 114 in response to an instruction from the control unit 111. The control unit 111 issues a request for writing the data (the write data transmitted to the nonvolatile memory interface 113 from the host interface 112) to the nonvolatile memory 13 via the nonvolatile memory interface 113. The control unit 111 updates the LUT 52 such that a physical address at which the data is written and a logical address are correlated with each other.

In a nonvolatile semiconductor memory such as a NAND flash memory in which random access is performed at a high speed, fragmentation of data on a physical address space does not cause deterioration in performance unlike in an HDD. On the other hand, fragmentation of data on a logical address space (also said to be fragmentation of a vacant region) increases a load on the host apparatus 2 side, for example, in the case where write/read commands which can be collectively issued under a situation in which there is no fragmentation have to be separately issued for a plurality of times. Thus, also in the case of an SSD implemented with, for example, a NAND flash memory assumed as the storage device 1 of the present embodiment, defragmentation may be performed in the same manner as the HDD to reduce fragmentation of data on the logical address space.

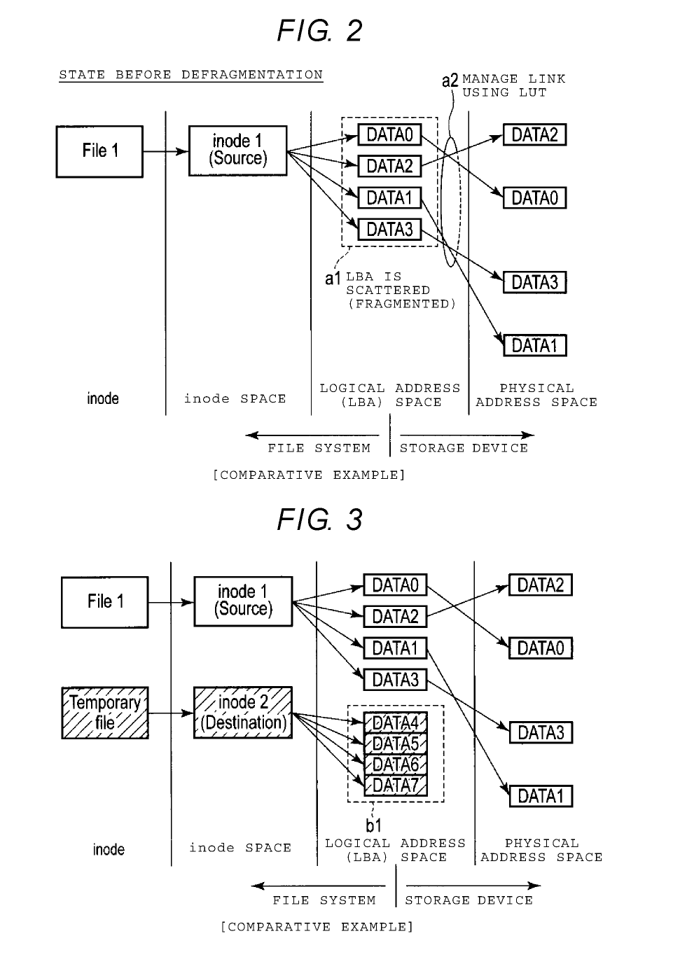

Here, for better understanding of the data arrangement method of the present embodiment, first, a general defragmentation method will be described with reference to FIGS. 2 to 6 by using a comparative example. Herein, a case is assumed in which a defragmentation target storage device (corresponding to the storage device 1 of the present embodiment) is an SSD, and defragmentation is performed to reduce fragmentation of data on the logical address space.

FIG. 2 illustrates a state before defragmentation.

As illustrated in FIG. 2, now, it is assumed that data of a file 1 (DATA0 to DATA3) is fragmented in a logical address space (a1 in FIG. 2). Herein, a state in which data of a single file which is to be correlated with consecutive regions of a logical address space is discretely correlated with a plurality of inconsecutive regions of the logical address space is referred to as fragmentation in the logical address space. Herein, it is assumed that the file system manages a file in a data structure called, for example, inode. A correspondence relationship between a logical address space and a physical address space is managed by an LUT (corresponding to the LUT 52 of the present embodiment) (a2 in FIG. 2).

In the case where defragmentation is performed to reduce fragmentation of data of the file 1 in the logical address space, a host apparatus (corresponding to the host apparatus 2 of the present embodiment) prepares a copy destination. More specifically, as illustrated in FIG. 3, the host apparatus finds out and allocates consecutive vacant regions in the logical address space on the file system (b1 in FIG. 3). For example, a temporary file including data with the same size as that of the data of the file 1 is created on the file system, and thus the consecutive vacant regions in the logical address space are allocated.

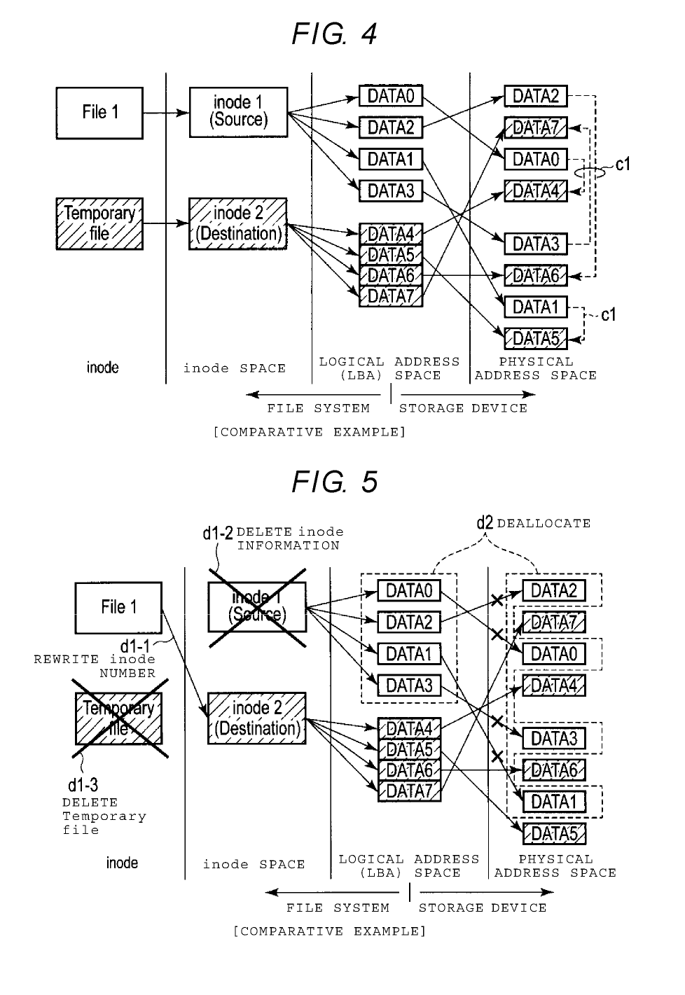

Referring to FIG. 4, the host apparatus issues a read command for reading the data of the file 1 (DATA0 to DATA3) to the storage device. For example, if a read command for the data DATA0 is received, the storage device converts a logical address included in the read command into a physical address by using the LUT, and reads the data DATA0 stored at the physical address. The remaining pieces of data DATA1 to DATA3 are read from the storage device in the same procedures. The host apparatus issues a write command for writing the read data (DATA0 to DATA3) as data of the temporary file (DATA4 to DATA7), to the storage device. The write command requests the data DATA0 to DATA3 read from the storage device to be written into the consecutive regions of the logical address space allocated to the data DATA4 to DATA7. If the write command is received, the storage device writes the data DATA4 to DATA7, and updates the LUT such that logical addresses allocated to the DATA4 to DATA7 are correlated with physical addresses at which the pieces of data DATA4 to DATA7 are written. As mentioned above, the physical address space in which the pieces of data DATA4 to DATA7 as are stored as a copy destination is correlated with the allocated logical address space through physical copying (c1 in FIG. 4). Here, it is noted that copying of data, more specifically, reading and writing of the data in the physical address space are performed in the storage device.

Next, the host apparatus changes a link of the file 1. More specifically, as illustrated in FIG. 5, the host apparatus rewrites an inode number (d1-1 in FIG. 5), deletes the original inode information (d1-2 in FIG. 5), and deletes the temporary file (d1-3 in FIG. 5), in the file system. The host apparatus issues, to the storage device, a deallocate command for making a request for invalidating the correspondence relationship between the regions of the logical address space allocated to the pieces of data DATA0 to DATA3 as a copy source and the physical address space in which the pieces of data DATA0 to DATA3 as the copy source are stored (d2 in FIG. 5). If the deallocate command is received, the storage device updates the LUT to invalidate a correspondence relationship between a logical address included in the deallocate command and a physical address correlated with the logical address. The deallocate command is also referred to as an unmap command, a trim command, or the like.

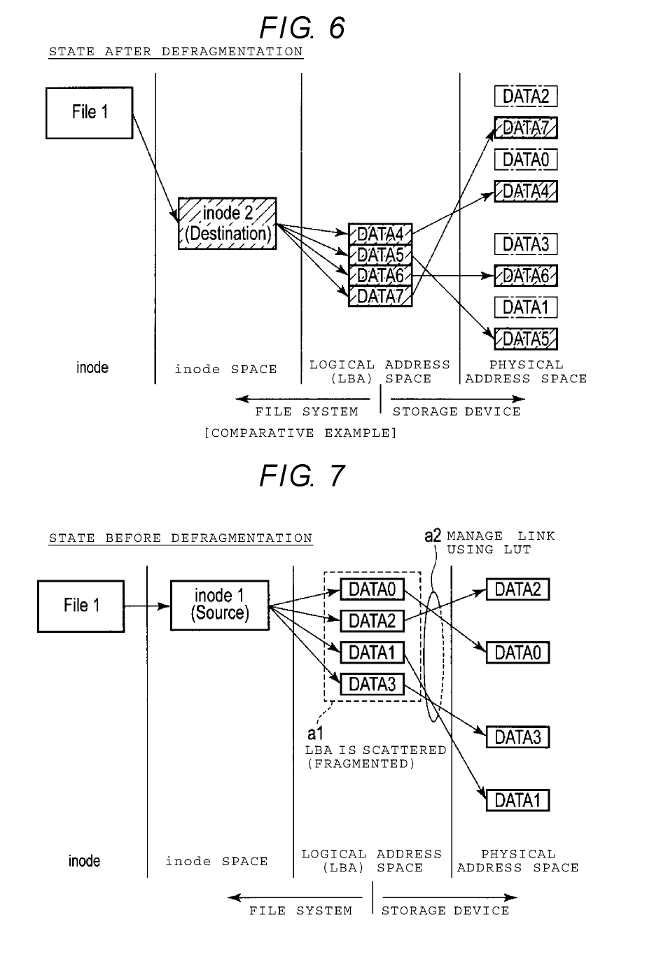

FIG. 6 illustrates a state after defragmentation.

As illustrated in FIG. 6, fragmentation of the data of the file 1 is reduced in the logical address space. For example, in the case of the state illustrated in FIG. 2, when the file 1 is read, four read commands are issued from the host apparatus to the SSD, and, in the case of the state illustrated in FIG. 6, a single read command is issued. Therefore, a load on the host apparatus side can be reduced through defragmentation. If vacant regions of the logical address space are consecutive, the same applies for a write command. On the other hand, as described above, in the storage device, copying of data, more specifically, reading and writing of the data in the physical address space are performed. This causes an increase in a WAF.

Next, with reference to FIGS. 7 to 11, the data arrangement method of the present embodiment will be described. The storage device 1 includes the link connection processing unit 201 and the link disconnection processing unit 202 to perform the data arrangement method.

Also herein, as illustrated in FIG. 7, it is assumed that data of a file 1 (DATA0 to DATA3) is fragmented on a logical address space (a1 in FIG. 7). For better understanding, FIG. 7 illustrates the same state as the state illustrated in FIG. 2 described in the comparative example. A correspondence relationship between a logical address space and a physical address space is managed by the LUT 52 (a2 in FIG. 7).

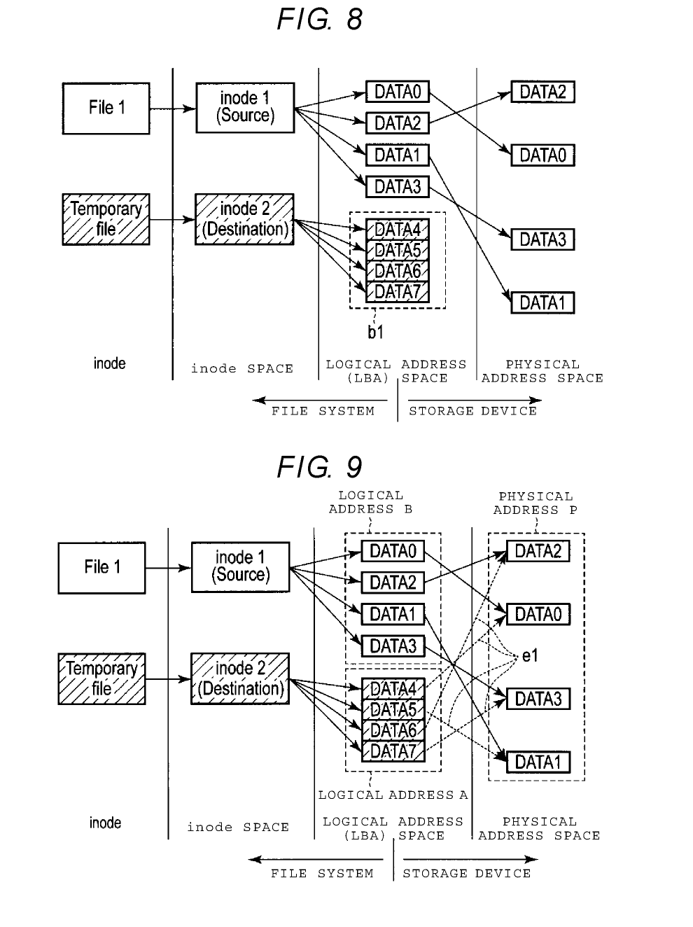

In the data arrangement method of the present embodiment, first, the host apparatus 2 prepares a movement destination (hereinafter, simply referred to as movement) in the logical address space. More specifically, as illustrated in FIG. 8, the host apparatus 2 finds out and allocates consecutive vacant regions in the logical address space in the file system (b1 in FIG. 8). For example, a temporary file including data with the same size as that of the data of the file 1 is created on the file system, and thus the consecutive vacant regions in the logical address space are allocated.

Next, in the data arrangement method of the present embodiment, as illustrated in FIG. 9, the host apparatus 2 issues a new command (which will be described later) to the storage device 1, so as to make a request for correlating regions in the logical address space allocated to the pieces of data DATA4 to DATA7 as the movement destinations with regions in the physical address space which are correlated with regions in the logical address space allocated to the pieces of data DATA0 to DATA3 as movement sources (e1 in FIG. 9). For example, the command designates two logical addresses such as a logical address (logical address A) not correlated with any address of the physical address space and a logical address (logical address B) correlated with a physical address (physical address P). For example, the host apparatus 2 issues (1) a command which designates a logical address allocated to the data DATA4 as the logical address A and a logical address allocated to the data DATA0 as the logical address B, (2) a command which designates a logical address allocated to the data DATA5 as the logical address A and a logical address allocated to the data DATA1 as the logical address B, (3) a command which designates a logical address allocated to the data DATA6 as the logical address A and a logical address allocated to the data DATA2 as the logical address B, and (4) a command which designates a logical address allocated to the data DATA7 as the logical address A and a logical address allocated to the data DATA3 as the logical address B. The physical addresses P which are a processing target of the command are (1) a physical address correlated with the logical address allocated to the data DATA0, (2) a physical address correlated with the logical address allocated to the data DATA1, (3) a physical address correlated with the logical address allocated to the data DATA2, and (4) a physical address correlated with the logical address allocated to the data DATA3. If the command is received, the storage device 1 updates the LUT 52 such that the logical addresses A are correlated with the physical addresses P which have been correlated with the logical addresses B. More specifically, regions in the logical address space allocated to the pieces of data DATA4 to DATA7 (regions designated as the logical address A) as the movement destinations are correlated with regions in the physical address space (regions of the physical addresses P) which have been correlated with regions in the logical address space allocated to the pieces of data DATA0 to DATA3 (regions designated as the logical addresses B) as the movement sources. At this time, the storage device 1 maintains the correspondence relationship between the regions in the logical address space allocated to the pieces of data DATA0 to DATA3 (regions designated as the logical addresses B) as the movement sources and the regions in the physical address space in which the pieces of data DATA0 to DATA3 are stored (regions of the physical addresses P). In other words, the regions in the physical address space in which the pieces of data DATA0 to DATA3 (regions of the physical addresses P) are stored are in a state of being correlated with both of the regions in the logical address space allocated to the pieces of data DATA0 to DATA3 (regions designated as the logical addresses B) as the movement sources and the regions in the logical address space allocated to the pieces of data DATA4 to DATA7 (regions designated as the logical addresses A) as the movement destinations. The link connection processing unit 201 is a processing unit which performs a process to handle this new command.

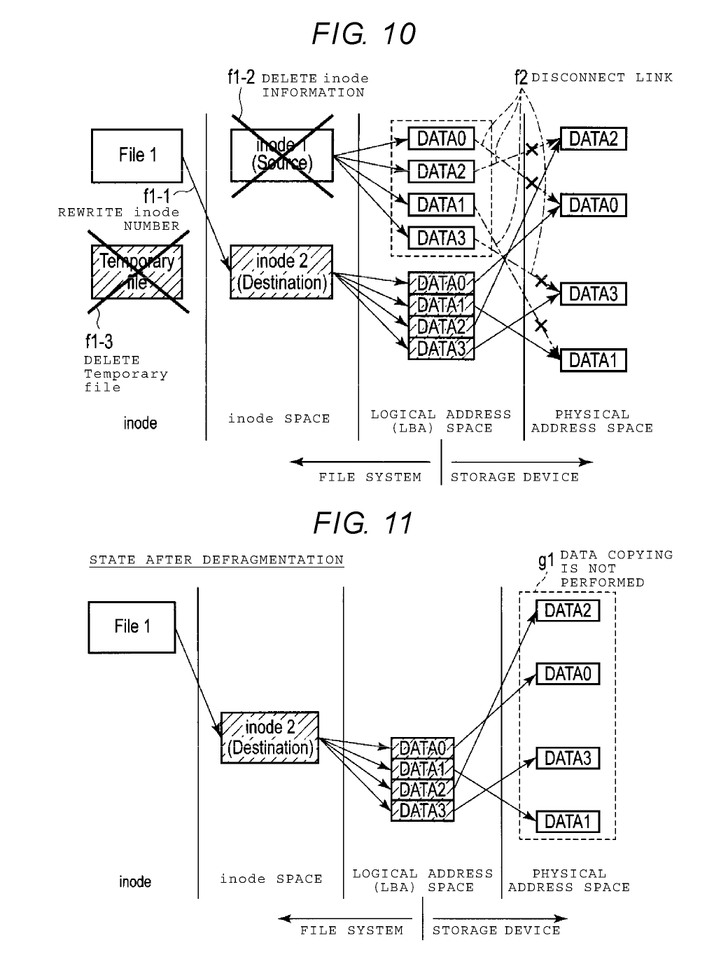

In the case where the regions in the logical address space allocated to the pieces of data DATA4 to DATA7 as the movement destinations are correlated with the regions in the physical address space which have been correlated with the regions in the logical address space allocated to the pieces of data DATA0 to DATA3 as the movement sources, the host apparatus 2 changes a link of the file 1. More specifically, in the same manner as in the comparative example, as illustrated in FIG. 10, the host apparatus 2 rewrites an inode number (f1-1 in FIG. 10), deletes the original inode information (f1-2 in FIG. 10), and deletes the temporary file (f1-3 in FIG. 10), in the file system. The host apparatus 2 issues, to the storage device 1, a deallocate command for making a request for invalidating the correspondence relationship between the regions in the logical address space allocated to the pieces of data DATA0 to DATA3 as the movement sources and the regions in the physical address space which have been correlated with the regions in the logical address space (f2 in FIG. 10). For example, the deallocate command designates a single logical address correlated with a physical address. For example, the host apparatus 2 issues (1) a deallocate command designating a logical address allocated to the data DATA0, (2) a deallocate command designating a logical address allocated to the data DATA1, (3) a deallocate command designating a logical address allocated to the data DATA2, and (4) a deallocate command designating a logical address allocated to the data DATA3. When the deallocate command is received, the storage device 1 updates the LUT 52 to invalidate the correspondence relationship between the logical address included in the deallocate command and the physical address correlated with the logical address, more specifically, to invalidate the correspondence relationship between the regions in the logical address space allocated to the pieces of data DATA0 to DATA3 as the movement sources and the regions in the physical address space correlated with the regions in the logical address space. In this case, the storage device 1 maintains the correspondence relationship between the regions in the logical address space allocated to the pieces of data DATA4 to DATA7 as the movement destinations and the regions in the physical address space which have been correlated with the regions in the logical address space allocated to the pieces of data DATA0 to DATA3 as the movement sources. The link disconnection processing unit 202 is a processing unit which performs a process to handle the deallocate command.

FIG. 11 illustrates a state after data arrangement is performed according to the data arrangement method of the present embodiment.

As illustrated in FIG. 11, fragmentation of the data of the file 1 is reduced in the logical address space. In the data arrangement method of the present embodiment, since only the LUT 52 has to be updated in the storage device 1, copying of data in the physical address space is not performed, and, more specifically, reading and writing of the data are not performed (g1 in FIG. 11), so that it is possible to prevent an increase in a WAF due to defragmentation.

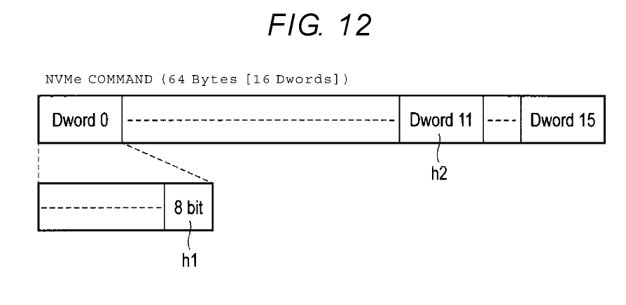

FIG. 12 is a diagram illustrating a format of an NVMe® command issued to the storage device 1 from the host apparatus 2.

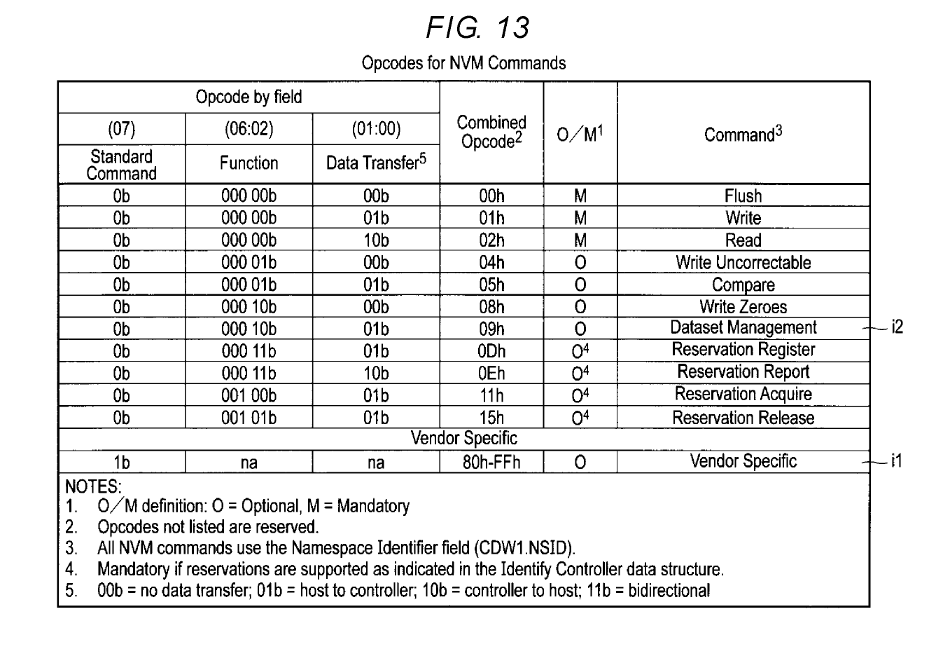

As described above, herein, it is assumed that a command defined in NVMe®, that is, an NVMe® command is issued from the host apparatus 2 to the storage device 1. As illustrated in FIG. 12, the NVMe® command includes 64 bytes (16 double words). Fields for storing values called opcodes are provided in lower 8 bits of a first double word (Dword 0) of the NVMe® command (h1 in FIG. 12). FIG. 13 illustrates a list of opcodes.

As illustrated in FIG. 13, among “00000000” to “11111111” which can be values of opcodes, 128 commands with such opcodes as “10000000” to “11111111” are defined as vendor specific commands (i1 in FIG. 11). Thus, in the data arrangement method of the present embodiment, one of the 128 vendor specific commands can be used as the new command. In other words, the controller 11 (link connection processing unit 201) interprets the one of the 128 vendor specific commands as the new command.

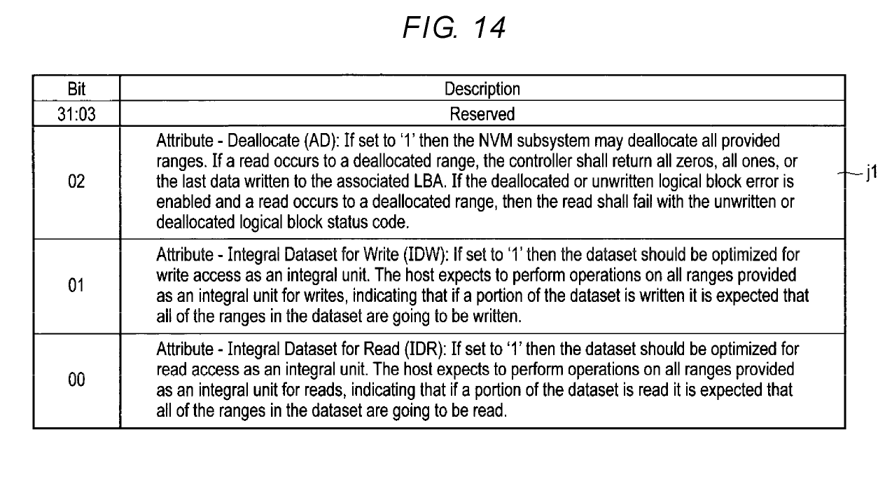

In the case where the opcode is “00001001”, the NVMe® command is defined to be treated as a dataset management command (i2 in FIG. 13). Each of double words, Dwords 10 to 15 of the NVMe® command, is defined depending on a command designated by an opcode, and, in the case of the dataset management command, a format of the double word, Dword 11, (h2 in FIG. 12) is defined as illustrated in FIG. 14.

As illustrated in FIG. 14, in the case where “1” is set to bit2 of the double word, Dword 11, the dataset management command is defined to be treated as a deallocate command (j1 in FIG. 14). In the data arrangement method of the present embodiment, the dataset management command in which “1” is set to bit2 of the double word, Dword 11 is used as the deallocate command. In other words, the controller 11 (link disconnection processing unit 202) interprets the dataset management command in which “1” is set to bit2 of the double word, Dword 11 as the deallocate command.

As described above, the data arrangement method of the present embodiment is not limited to PCIe® or NVMe®, and may be implemented by other various types of interfaces or protocols. In other words, the vendor specific command or the dataset management command of NVMe® is only an example, and any other commands may be used.

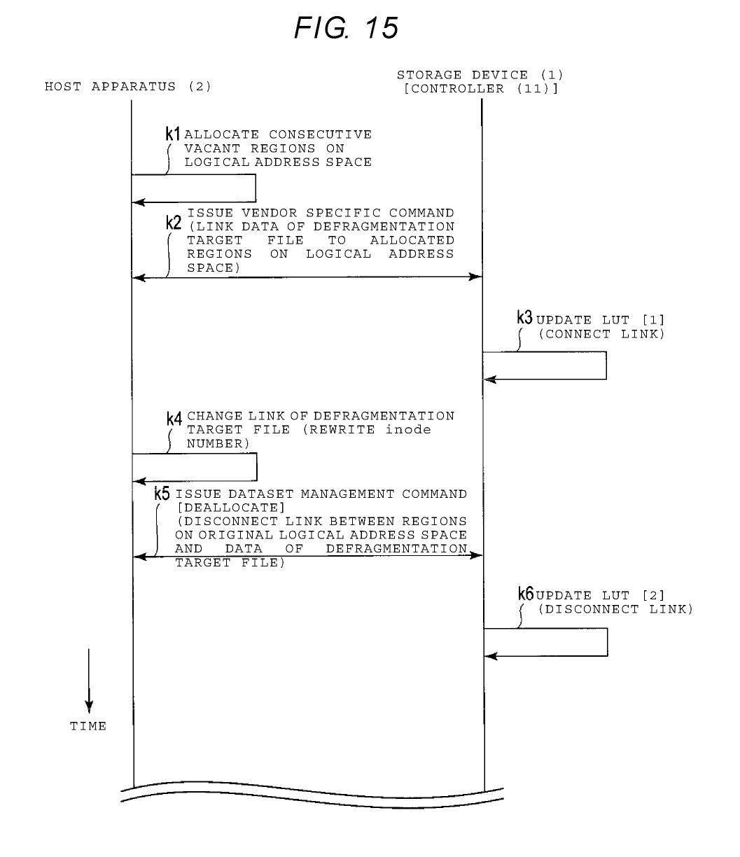

FIG. 15 is a diagram illustrating a flow of a data arrangement process performed through cooperation between the storage device 1 and the host apparatus 2.

First, the host apparatus 2 prepares a movement destination on a logical address space of a data arrangement target file. More specifically, the host apparatus 2 finds out and allocates consecutive vacant regions in the logical address space as work on the file system (k1 in FIG. 15).

The host apparatus 2 issues the vendor specific command to the storage device 1, so as to make a request for correlating a region in the logical address space allocated to data as a movement destination with a region on a physical address space correlated with a region on a logical address space allocated to data as a movement source (k2 in FIG. 15). For example, the vendor specific command designates two logical addresses such as a logical address (logical address A) not correlated with the physical address space and a logical address (logical address B) correlated with a physical address (physical address P). The storage device 1 having received the vendor specific command updates the LUT 52 such that the logical address A is correlated with the physical address P correlated with the logical address B, and, more specifically, the region in the logical address space allocated to the data as the movement destination is correlated with the region in the physical address space correlated with the region in the logical address space allocated to the data as the movement source (k3 in FIG. 15).

Next, the host apparatus 2 changes a link of the data arrangement target file. More specifically, an inode number is rewritten in the file system (k4 in FIG. 15). The host apparatus 2 issues, to the storage device, the dataset management command as a deallocate command to make a request for invalidating the correspondence relationship between the region in the logical address space allocated to the data as the movement source and the region in the physical address space correlated with the regions in the logical address space (k5 in FIG. 15).

The storage device 1 having received the dataset management command as a deallocate command updates the LUT 52 to invalidate the correspondence relationship between the logical address included in the deallocate command and the physical address correlated with the logical address, more specifically, to invalidate the correspondence relationship between the region in the logical address space allocated to the data as the movement source and the region in the physical address space correlated with the region in the logical address space (k6 in FIG. 15).

In the data arrangement method of the present embodiment, in the storage device 1, fragmentation in the logical address space can be reduced by only updating the LUT 52, so that it is possible to prevent an increase in a WAF due to defragmentation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a nonvolatile memory; and
a controller configured to access the nonvolatile memory in response to a command from a host apparatus, wherein the controller is configured to
in response to a first command which includes a first logical address and a second logical address, update a logical-to-physical address conversion map to correlate the second logical address with a physical address of the nonvolatile memory to which the first logical address is correlated, and
in response to a second command which includes the first logical address, update the logical-to-physical address conversion map to invalidate the correlation between the first logical address and the physical address.

2. The storage device according to claim 1, wherein
the logical-to-physical address conversion map is implemented as a lookup table.

3. The storage device according to claim 1,
wherein the host apparatus and the storage device perform communication with each other according to a protocol based on the NVM Express (NVMe®) standard, and
wherein one of a plurality of vendor specific commands defined in the NVMe® standard is interpreted as the first command.

4. The storage device according to claim 3,
wherein a dataset management command attached with an attribute of deallocate defined in the NVMe® standard is interpreted as the second command.

5. The storage device according to claim 1, wherein the controller is configured to:
in response to a third command which includes a third logical address and a fourth logical address, update the logical-to-physical address conversion map to correlate the fourth logical address with a second physical address of the nonvolatile memory to which the third logical address is correlated, and
in response to a fourth command which includes the third logical address, update the logical-to-physical address conversion map to invalidate the correlation between the third logical address and the second physical address.

6. The storage device according to claim 5, wherein the first and third logical addresses are logical addresses of a first file, and a fifth logical address that is not a logical address of the first file is between the first and third logical addresses in a logical address space.

7. The storage device according to claim 6, wherein
the second and fourth logical addresses are logical addresses of a second file, and are consecutive addresses in the logical address space, and
an inode number of the first file is changed from a first inode number corresponding to an inode of the first file to a second inode number corresponding to an inode of the second file.

8. A data arrangement method executed by a storage device having a nonvolatile memory and a host apparatus connected to the storage device, the method comprising:
in response to a first command which includes a first logical address and a second logical address, updating a logical-to-physical address conversion map to correlate the second logical address with a physical address of the nonvolatile memory to which the first logical address is correlated, and
in response to a second command which includes the first logical address, updating the logical-to-physical address conversion map to invalidate the correlation between the first logical address and the physical address.

9. The method according to claim 8, wherein
the logical-to-physical address conversion map is implemented as a lookup table.

10. The method according to claim 8,
wherein the host apparatus and the storage device perform communication with each other according to a protocol based on the NVM Express (NVMe®) standard, and
wherein one of a plurality of vendor specific commands defined in the NVMe® standard is interpreted as the first command.

11. The method according to claim 10,
wherein a dataset management command attached with an attribute of deallocate defined in the NVMe® standard is interpreted as the second command.

12. The method according to claim 8, further comprising:
in response to a third command which includes a third logical address and a fourth logical address, updating the logical-to-physical address conversion map to correlate the fourth logical address with a second physical address of the nonvolatile memory to which the third logical address is correlated, and
in response to a fourth command which includes the third logical address, updating the logical-to-physical address conversion map to invalidate the correlation between the third logical address and the second physical address.

13. The method according to claim 12, wherein the first and third logical addresses are logical addresses of a first file, and a fifth logical address that is not a logical address of the first file is between the first and third logical addresses in a logical address space.

14. The method according to claim 13, wherein
the second and fourth logical addresses are logical addresses of a second file, and are consecutive addresses in the logical address space, and
an inode number of the first file is changed from a first inode number corresponding to an inode of the first file to a second inode number corresponding to an inode of the second file.

15. A method of defragmenting logical addresses of a file that is stored in a storage device, which includes a first logical address correlated with a first physical address and a second logical address correlated with a second physical address, said method comprising:
creating a temporary file having third and fourth logical addresses that are consecutive in a logical address space;
issuing first and second commands of a first type to the storage device, the first command including the first and third logical addresses and the second command including the second and fourth logical addresses, wherein the storage device, in response to the first command, updates a logical-to-physical address conversion map to correlate the third logical address with the first physical address and, in response to the second command, updates the logical-to-physical address conversion map to correlate the fourth logical address with the second physical address; and
issuing third and fourth commands of a second type to the storage device, the third command including the first logical address and the fourth command including the second logical address, wherein the storage device, in response to the third command, updates the logical-to-physical address conversion map to invalidate the correlation between the first logical address and the first physical address and, in response to the fourth command, updates the logical-to-physical address conversion map to invalidate the correlation between the second logical address and the second physical address.

16. The method according to claim 15, wherein
the logical-to-physical address conversion map is implemented as a lookup table.

17. The method according to claim 15,
wherein the host apparatus and the storage device perform communication with each other according to a protocol based on the NVM Express (NVMe®) standard, and
wherein one of a plurality of vendor specific commands defined in the NVMe® standard is interpreted as the command of the first type.

18. The method according to claim 17,
wherein a dataset management command attached with an attribute of deallocate defined in the NVMe® standard is interpreted as the command of the second type.

19. The method according to claim 15, further comprising:
changing an inode number of the file from a first inode number corresponding to an inode of the file and a second inode number corresponding to an inode of the temporary file.

20. The method according to claim 19, wherein the inode number of the file is changed prior to issuing the third and fourth commands.
